(19) United States
(12) Patent Application Publication
(10) Pub. No.: US 2007/0173236 A1
(43) Pub. Date: Jul. 26, 2007

(54) Methods for Marketing Digital Content to Mobile Communication Device Users

(75) Inventors: Kumar K. Vishwanathan, Windham, NH (US); Prakash R. Iyer, North Andover, MA (US); Rangamani Sundar, Windham, NH (US)

Correspondence Address: EDELL, SHAPIRO & FINNAN, LLC, 1901 RESEARCH BOULEVARD, SUITE 400, ROCKVILLE, MD, 20850, US

(73) Assignee: ENVIO NETWORKS INC., Andover, MA (US)

(21) Appl. No.: 11/626,493

(22) Filed: Jan. 24, 2007

Related U.S. Application Data
(60) Provisional application No. 60/761,372, filed on Jan. 24, 2006.
(60) Provisional application No. 60/789,900, filed on Apr. 7, 2006.

(51) Int. Cl. H04Q 7/38

(52) U.S. Cl. 455/414.1

(57) ABSTRACT

Systems and methods are provided for allowing mobile device users to select digital content for use or to recommend to other mobile device users to facilitate marketing of digital content among mobile device users. In addition, systems and methods are provided to facilitate sharing of mobile device user's ratings of digital content among users having similar interests. Further still, a system and method are provided for awarding points to mobile device users from purchases made by other mobile device users of digital content.

### RELATED APPLICATIONS

This application claims priority to U.S. Provisional Application No. 60/761,372, filed Jan. 24, 2006, and to U.S. Provisional Application No. 60/789,900, filed Apr. 7, 2006. The entirety of each of these applications is incorporated herein by reference.

### FIELD OF THE INVENTION

The present invention is directed to mobile communication devices and services.

### BACKGROUND OF THE INVENTION

Mobile communication devices, e.g. cellular phones, are becoming more data centric and less voice centric and the modern mobile lifestyle is changing rapidly. Indeed, in many countries, the mobile phone is the “primary screen” in the household instead of a laptop or desktop computer. Consequently, for many people the mobile device is the person's portal to non-telephony types of services, such as music, videos, photographs and other digital content.

Techniques are needed to market digital content to mobile device users.

### SUMMARY OF THE INVENTION

Briefly, according to another aspect of the invention, a selection capability is provided for the use of digital content to be presented to a caller when the caller makes a call to a mobile device, a so-called ringback tone. When a call is placed by a caller to the mobile device, information is obtained that includes a list of a plurality of digital content options for a ringback tone to be presented to the caller when the caller makes calls the mobile device. The mobile device user or the caller can select which of the plurality of ringback tone options is used and presented to the caller when making calls to the mobile device.

According to another embodiment of the invention, a system and method are provided for delivering digital content to a mobile device whereby preference information built from monitoring downloads by mobile device user is used to market digital content to mobile device users.

According to still another embodiment of the invention, a system and method are provided to facilitate sharing of mobile device user's ratings of digital content among users having similar interests. For example, a first mobile device user may select digital content to be played as a ringback tone to a second mobile device user. The second mobile device user may be prompted to rate the digital content and the second mobile device user's rating may be communicated to the first mobile device user. Alternatively or in addition, the second mobile device user may supply a recommendation for other digital content and the recommendation is communicated to the first mobile device user.

According to still another embodiment of the invention, a system and method are provided for awarding points to a first mobile device user based on purchases/downloads of digital content that other mobile device users make based on digital content presented to those other mobile device users during communication sessions with the mobile device user.

Objects and advantages of the techniques described herein will become more readily apparent when reference is made to the following description taken in conjunction with the accompanying drawings.

### BRIEF DESCRIPTION OF THE DRAWINGS

FIG. 1 is a high level block diagram showing a mobile communication system according to an embodiment of the present invention.

FIG. 2 is a high level data flow diagram showing a concurrency application server that communications with a library component in a mobile device according to embodiments of the present invention.

FIG. 3 is an electrical block diagram of a mobile device according to an embodiment of the present invention.

FIG. 4 is a block diagram of the software architecture of the concurrency application system according to an embodiment of the present invention.

FIG. 5 is a block diagram showing how the concurrency application server interacts between digital content servers and sites and mobile devices according to embodiments of the present invention.

FIG. 6 is a flow diagram for a method according to an embodiment of the invention in which a mobile device user may select digital content to be used as a ringback tone for calls from another mobile device user.

FIG. 7 is a flow diagram for a method according to an embodiment of the invention in which a caller may select digital content to be used as a ringback tone when calling a mobile device user.

FIG. 8 is a flow diagram for a method according to an embodiment of the invention in which a caller can recommend digital content to a mobile device user.

FIGS. 9 and 10 are flow diagrams for methods according to embodiments of the invention in which mobile device user preferences for digital content downloads is used to enable a mobile device user to select content suitable to other mobile device users.

FIG. 11 is a flow diagram for a method according to an embodiment of the invention in which mobile device users may rate digital media content.

FIG. 12 is a flow diagram for a method according to an embodiment of the invention in which mobile device users may earn points for promoting sales of digital content to other mobile device users.

### DETAILED DESCRIPTION

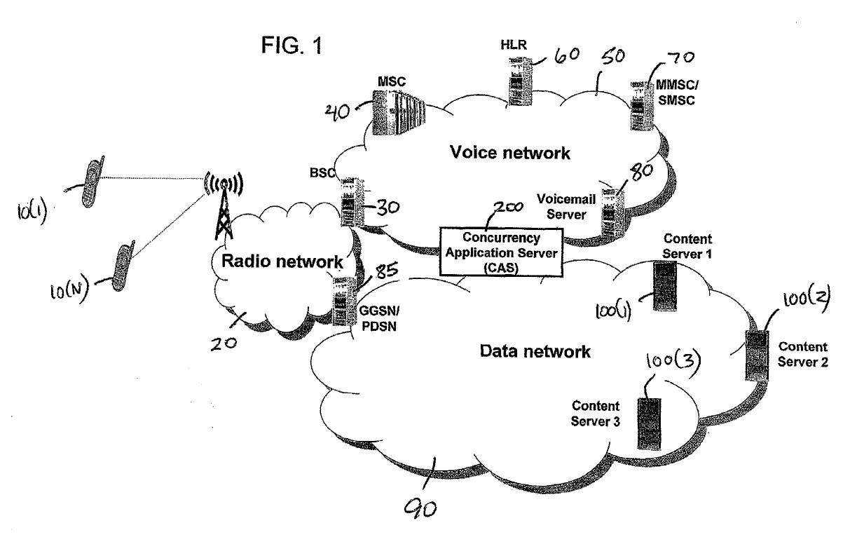

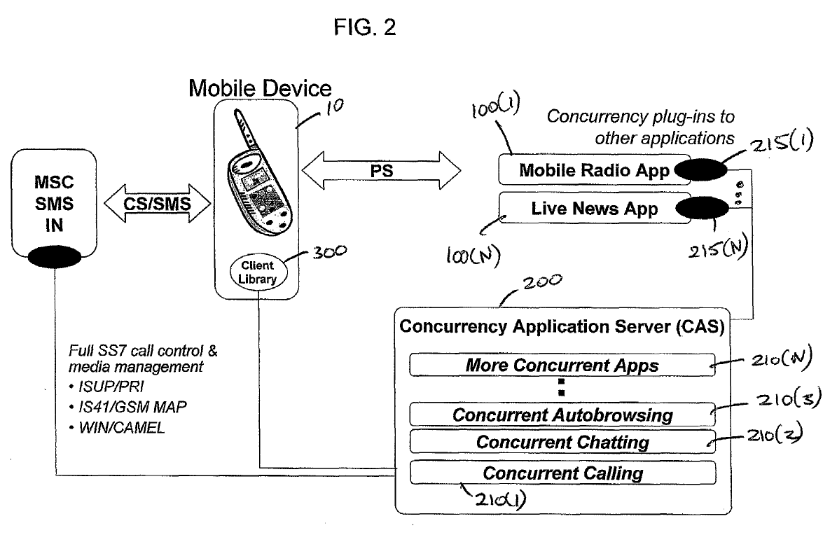

Referring first to FIGS. 1 and 2, the system and method for delivering digital content to mobile devices will be described. The mobile communication devices are shown at reference numeral 10(1) to 10(N) and may be cellular phone or other wireless communication devices that have sufficient display and user interface capability beyond simple telephony functions. Such devices are currently available and they have capabilities including mobile web browsing, mobile instant messaging and related capabilities.

As is known in the art, mobile communication devices 10(1)-10(N) achieve a wireless radio communication link via a radio network 20 to base station control centers (BSCs) 30 and the BSCs 30 are in turn connected to a mobile switching center (MSC) 40 that is part of a voice network 50. Also in the voice network 50 is a home location register (HLR) 60 and a multimedia messaging service center/short message service center (MMSC/SMSC) 70 and a voicemail server 80. The MMSC/SMSC 70 handles processing of data messages to/from a mobile communication device. The radio network 20 is also connected to a data or packet network 90 by a GSM gateway serving node (GGSN)/packet data serving node (PDSN)/wireless internet access router 85. Alternatively, multimodal mobile handsets may connect to the IP network via any other available radio technology like WiFi (IEEE 802.11), WiMax (IEEE 802.16) etc. The data network 90 may include content servers 100(1), 100(2) and 100(3) that are accessible via the WWW for digital content.

According to the present invention, a mobile content system is provided that comprises a concurrency application server (CAS) 200 and a small client library 300 also called a concurrency application plug-in that resides in the mobile devices 10(1) to 10(N). The CAS 200 interfaces with equipment in the voice network 50 and equipment in the data network 90, e.g., the Internet. A mobile device 10(i) equipped with the concurrency application plug-in is said to be a concurrency-enabled mobile device. Thus, any currently available or hereinafter developed mobile device having the aforementioned user interface capabilities may be made concurrency-enabled by installing the client library 300 or otherwise configured with the functionality of the client library 300 as described herein. For example, the client library functionality may made part of the operating system of a mobile device.

The CAS 200 comprises an interface function (described hereinafter) that detects incoming calls or communication sessions that may be originate from an MSC or MMSC/SMSC. Depending on which concurrent applications the mobile device user has subscribed, the CAS 200 activates a mobile application. The CAS 200 comprises a plurality of mobile applications 210(1) to 210(N) that can be running concurrently in cooperation with a client library 300 on any number of mobile devices 10. Examples of mobile applications include a voice calling application 210(1), voice mail application 210(2), chatting application 210(3) and autobrowsing application 210(4). Additional mobile applications are described hereinafter. The mobile applications 210(1) to 210(N) may interface with third party applications 110(1) to 110(N) which may include, for example, a mobile radio application 110(1) and a live news application 110(N), as well as a mobile gaming application 120(1). The CAS 200 comprises concurrent application plug-ins 215(1) to 215(M) to enable interaction between the CAS applications and the third party applications.

A concurrent mobile application may be initiated by the CAS 200 as explained above or by the mobile device as well. For example, the client library 300 on the mobile device may activate a mobile application based on an incoming call or certain incoming message notifications. Thus, the mobile device or the CAS 200 may detect the need for concurrency and activate a mobile application concurrent with an already activated mobile application.

The functions of the CAS 200, such as the content delivery functions described herein, may be embodied by one or more computer program instructions that, when executed by computer processor, cause the computer processor to perform the functions that are described herein.

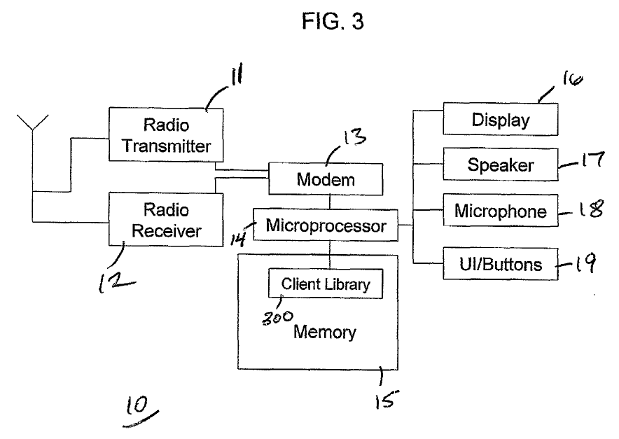

FIG. 3 illustrates a block diagram of a mobile device 10 according to one embodiment. The mobile device 10 comprises a radio transmitter 11, a radio receiver 12, a modem (baseband signal processor) 13, microprocessor 14, memory 15 and a variety of user interface components such as a display 16, speaker 17, microphone 18 and user interface buttons 19. The functions of many of the components are well known in the art and are therefore not described in detail herein. The client library 300 is installed in the memory 15. In addition to the client library 300, the memory 15 stores other software programs that are executed by the microprocessor 14 to provide the various mobile device functions to the user and coordinate cooperation with the CAS 200. The mobile device 10 need have only one instance each of a radio transmitter 11 and a radio receiver 12 to provide for multiple concurrent mobile applications to the device user. No modification to the hardware of a mobile device is necessary to achieve the concurrent mobile application functionality described herein. Moreover, no modification of the over-the-air communication protocol (between a mobile device and the radio network 20) is necessary to provide the concurrent application functionality described herein.

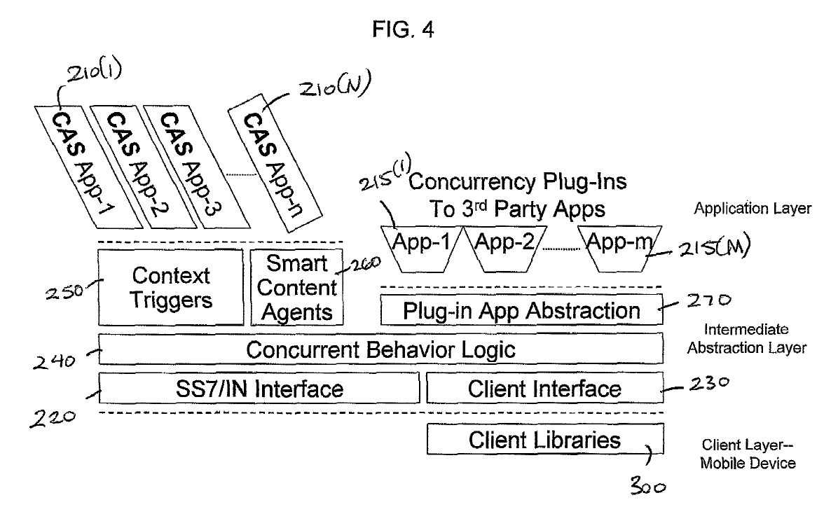

FIG. 4 illustrates an example of a software architecture for the concurrency application system functionality. As mentioned above, at the client layer there is a client library (concurrency application plug-in enabler) 300 that resides in the mobile device 10 that can activate an application while others are already active on the mobile device 10 and can switch an active application between the foregoing and background, either in response to a user control or automatically.

At an intermediate abstraction layer there is a SS7/IN interface function 220 and a client interface function 230. The SS7/IN interface function 220 detects call context information from a mobile device call. Call context parameter information includes, but is not limited to, information such as the mobile device ID, telephone number of the mobile device, the number called by the mobile device, etc., obtained from the MSC and location of the mobile device or other information obtained from or via the GGSN/PDSN/WirelessRouter 85. In addition, the client interface function 230 receives any special data from the mobile device 10 and delivers concurrency application information or content to the mobile device 10 in the appropriate format depending on the capabilities of the mobile device. There is also a concurrent behavior logic function 240 that maintains a profile data file for each mobile device 10 as to the types of concurrent applications to be provided to a mobile device and parameters associated with the concurrent application, which applications are active or available on a particular mobile device, etc. Next, there are a context triggers function 250 and a smart content agents function 260. The context trigger function 250 determines what type of concurrent applications should be invoked for a mobile device based on the context of the current activity of the mobile device (type of call made, time of day of the call, location of the mobile device when a call is made, calling number of the call, duration of the call in progress, etc.). Other context triggers may be location based, such as the absolute location of a mobile device user as well as the proximity of one mobile device user to another mobile device user. The location information can be absolute GPS-based or relative RFID-based, technologies for which are known in the art and used or will be used in mobile communication networks and services. The smart content agents function 260 activates one or more concurrent applications to retrieve certain content relevant to the context of a mobile device call, under control of the context trigger function 250.

The appropriate one or more CAS applications (CAS App-1 to CAS App-n) 210(1) to 210(N) are called upon by the context trigger and smart content agents functions 250 and 260. In addition, there is a plug-in application abstraction function 270 that interfaces the concurrent behavior logic function 240 with one or more concurrency application plug-ins 215(1) to 215(M).

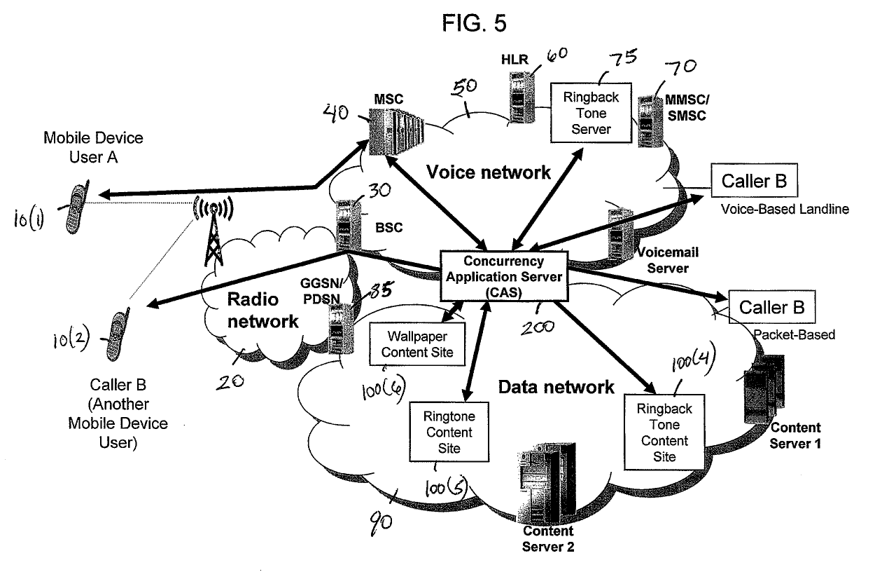

Reference is now made to FIG. 5. FIG. 5 is similar to FIG. 1 but illustrates examples of digital media content sites or servers that are involved in various aspects of the present invention. The term “digital media content” used herein is meant to include audio content, visual content and audio/visual content. Examples of audio content include music (samples or clips from songs, or an entire song), custom audio clips, tones, ringtones, ringback tones, etc. As is known in the art, a “ringback tone” is the sound made by the phone network to indicate a ringing phone to the calling party (caller). In other words, the ringback tone is the sound that a caller hears when calling another party before the call answered by that other party. The conventional ringback tone is simply a ringing tone, but many telephone network service providers provide a capability of changing the ringback tone to be an audio clip, predetermined combination of tones, etc. According to the present invention, a ringback tone selection function is provided to allow a mobile device user to change the ringback tone configuration for calls made to him/her by another party. The term “ringback tone” is meant to include tones (in a variety of patterns), ring types, audio voice sound clips, music sound clips (instrumental or with voice), etc., or any combination thereof. The mobile network infrastructure includes the capability to generate one of a plurality of ringback tones, to change the ringback tone and to download ringback tones from ringback tone provider on behalf of the called party. Examples of visual content includes digital images, such as photographs, artwork (such as artwork associated with a compilation of music on a compact disk release—called “album” or “CD” art), and digital videos. Examples of audio/visual content includes digital videos (with video and audio) such as music videos, user-made videos that a user uploads to a digital content site (e.g., YouTube™ or Yahoo™), as well as digital video segments from a movie, television show, etc.

The digital media content may be used on a user's device in several ways. One use of the digital media content is an alert indication associated with an incoming call like a ringtone. Again, a ringtone is the alert made on a mobile device to the mobile device user who is receiving a call from another mobile device user. A mobile device user can select from a variety of installed or downloadable ringtones to be activated when receiving a call from another particular mobile device user. Digital audio, visual or audio/visual content could be used as an alert indication.

Another use of the digital media content is simply to experience the digital content from the mobile device, by way of playback (audio, visual or audio/visual) or display. For example, currently available mobile devices have displays that are capable of displaying user-selectable “wallpaper”, such as a digital image derived from a photograph taken by a user with his/her suitably equipped mobile device, taken by another mobile device user who has sent it to that user. The “wallpaper” image displayed on the mobile device may also depend on state or mode that the device is in. For example, there may be a default wallpaper image when the device is in a standby state (not making a call or receiving a call). However, the device may be configured to display a particular wallpaper image selected by the user as an alert indication, e.g., when the mobile device is receiving a call or email message from another particular mobile device user or when placing a call or sending an email message to another particular mobile device user. The wallpaper images may also be downloaded for free or in exchange for a payment made by mobile device user from the CAS or other wallpaper image content site (similar to the ringback tone site) connected to the CAS via the Internet, etc. Other examples of wallpaper images may be music CD cover art, movie characters or images, television show characters or images, photos of celebrities, photos of popular musicians, images of famous artwork, well known photographs, web clips etc. Wallpaper image content may be further generalized to include short digital video segments such as a movie trailer, music video, popular television show, etc.

In the system shown in FIG. 5, there may be a ringback tone server 75 in the voice network 50, a ringback tone content web site 100(4), a ringtone content site 100(5) and a wallpaper content site 100(6) in the data network 90. This meant to be by way of example only. Any of theses servers or sites may store and license to users digital content (audio, visual or audio/visual) for use in accordance with the various embodiments of the present invention described herein.

For purposes of describing various embodiments of the invention, the party that receives the call, i.e., the mobile device user is referred to as mobile device user A (called party) and the party that is placing the call is referred to as caller B. Caller B may be another mobile device user as indicated on the left side of FIG. 5, a voice-based landline device user or a packet-based device user (e.g., voice-over-IP, wired or wireless) as shown on the right side of FIG. 5. The mobile device user A is assumed to have a subscription (or otherwise purchased the rights) to a variety of ringback tones provided by a ringback tone server.

Currently, there are separate servers that store for distribution ringtones, ringback tones and wallpaper content as shown in FIG. 5. The CAS 200 stores download preferences for each of its mobile device users as to the digital content (e.g., ringtones, ringback tones and wallpaper content) that each user has purchased/subscribed and uses this information to up sell additional content that matches a user's preferences. This user preference information may also contain data pertaining to other goods or services (such as digital music, digital video, clothing, restaurants, etc.) a user has purchased with their mobile device in order to target the sale of ringtone, ringback tone or wallpaper content to a user. Alternatively, the CAS 200 itself may store this content and therefore distribute all of these types of media content to mobile device users without the use of such third party content servers.

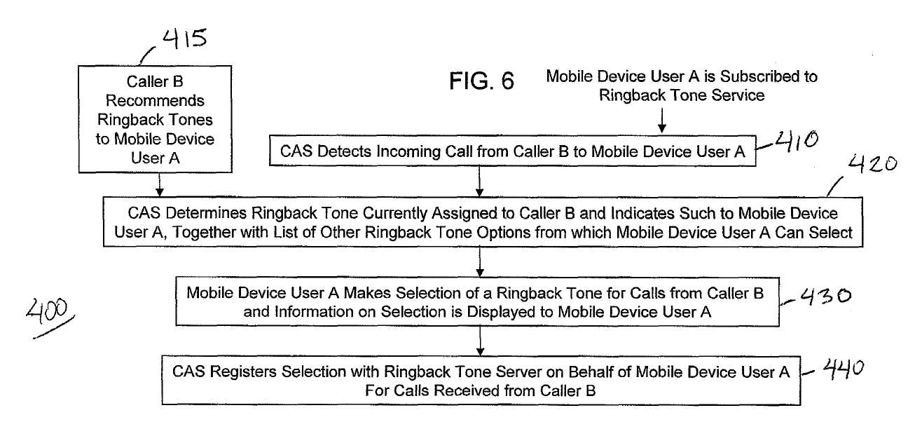

Referring now to FIG. 6, in conjunction with FIG. 5, a first embodiment of the invention is described with respect to the flow chart 400. At 410, the CAS 200 detects an incoming call to mobile device user A from caller B. At 420, the CAS 200, through its service connection to various ringback tone servers (one of which is shown at 75), determines the ringback tone currently assigned to caller B for calls placed by caller B to mobile device user A. At 415, caller B may send to mobile device user A recommendations for ringback tones, which are included in the list of ringback tone options presented to mobile device user A in 420. Also at 420, the CAS 200 generates a list of ringback tone options that are available to mobile device user A (based on mobile device user A's subscription with his/her ringback tone service provider and/or based on knowledge of the ringback tones already installed on the mobile device 10(1)). Also at 420, the CAS presents to the mobile device user the list of ringback tone options as well as an indication of the ringback tone currently assigned to caller B. As is known in the art, visual information about ringback tones can be displayed by a descriptive name given to the tone by the ringback tone service provider. Thus, the list of ringback tone options may comprise a list of the ringback tone names. The mobile device user can hear samples of the ringback tones by selecting (via a suitable user interface on the mobile device handset) one of the ringback tones for retrieval by the CAS and download from the ringback tone server for playback.

When mobile device user A receives the list of ringback tone options, he/she may make a selection from the list, at 430, via a suitable user interface on the mobile device handset, to be used (played to caller B) when receiving calls from caller B (based on caller B's telephone number). At 430, the CAS 200 registers the selection made by the mobile device user A with the ringback tone server, and with its own database of preference information for mobile device user A. Thus, in the future, whenever caller B (whether caller B is another mobile device user, a voice-based landline user or packet-based user) calls mobile device user A, the CAS 200 retrieves the new ringback tone assigned to caller B and presents that ringback tone to caller B.

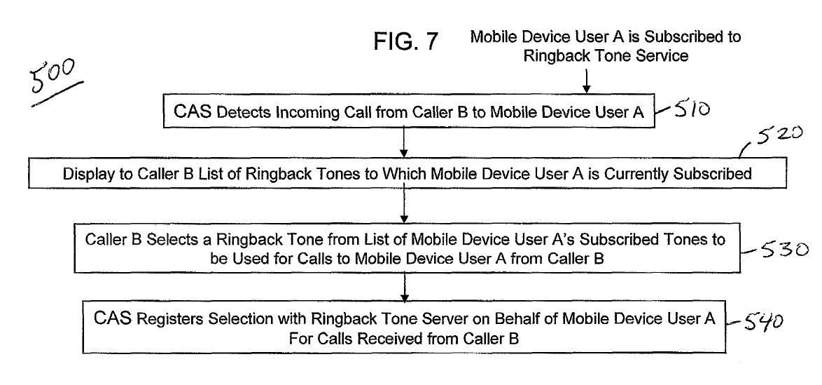

Turning now to FIG. 7, in conjunction with FIG. 5, a ringback tone selection process 500 according to another embodiment of the invention is described. In this embodiment, it is assumed the appropriate permissions and opt-ins are granted, and that the caller B uses his/her device (mobile, voice-based landline, packet-based, etc.) that has capabilities to allow caller B to see a list of ringback tones that mobile device user A has the right to use. In this case, at 510 when the CAS 200 detects an incoming call to mobile device user A from caller B, it determines which ringback tones are available to (or have been subscribed by) mobile device user A and generates a list of those ringback tones for presentation to caller B at 520. At 530, caller B then selects a ringback tone from the list of mobile device user A's subscribed tones to be used on mobile device user A's handset when caller B calls mobile device user A. At 540, the CAS retrieves from the ringback tone server the data for the selected ringback tone and downloads it. Also at 540, the CAS registers this selection with the ringback tone server on behalf of mobile device user A, and in the database of user preferences associated with the CAS. In the future, whenever caller B calls mobile device user A, the CAS retrieves the ringback tone selected by caller B for presentation to caller B.

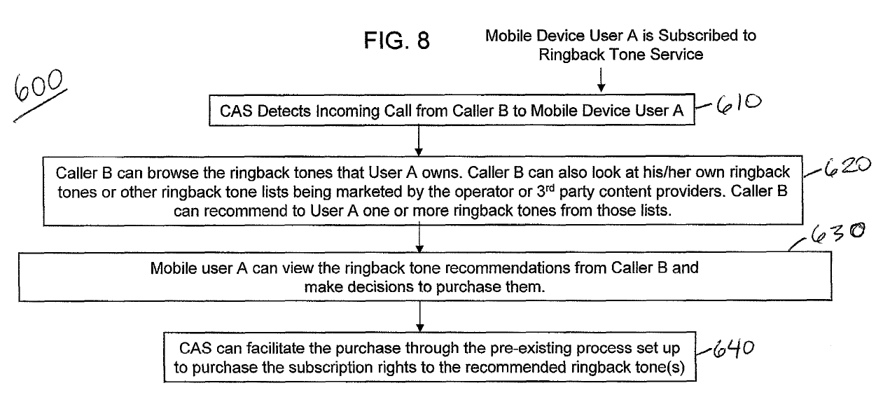

Turning to FIG. 8, in conjunction with FIG. 7, a ringback tone selection process 600 according to still another embodiment is described. The CAS 200 detects an incoming call from caller B to mobile device user A at 610. In this embodiment, at 620, caller B is presented with a list of ringback tone options based on those to which mobile device user A has subscribed and those to which caller B has subscribed (to be used when callers make calls to caller B). At 620, caller B can select one or more of the ringback options from these lists and at 630 the CAS 200 presents this information to mobile device user A as the ringback tone options that caller B recommends. At 630, mobile device user A can then make a decision to purchase the subscription rights to use the recommended ringback tone(s) and at 640 the CAS 200 executes the purchasing transaction with the ringback tone provider on behalf of the mobile device user A. Thus, when caller B makes calls to mobile device user A, the CAS retrieves the ringback tone selected by the mobile device user A for presentation to caller B.

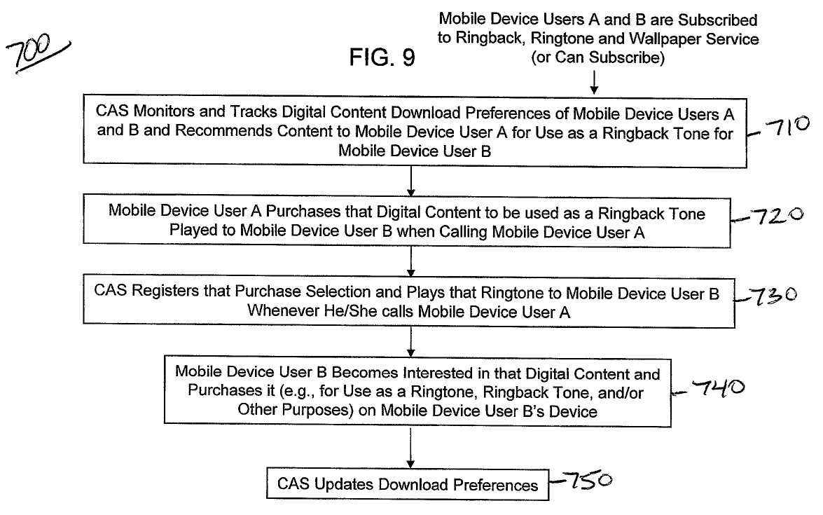

With reference to FIG. 9, another embodiment of the invention will be described. According to this embodiment, a system and method 700 for a business model is provided in which the CAS 200 recommends for up sell digital content based on digital content downloaded by a mobile device user. In this example, the CAS 200 recommends digital content to be used by a mobile device user as a ringback tone, but the digital content may be used for other purposes as well.

At 710, the CAS monitors and tracks digital content download preferences of its mobile device users, e.g., mobile device (10(1)) user A and mobile device (10(2)) user B. Based on preference information the CAS recommends to mobile device user A to purchase digital content at 720, for example, a particular popular song, for example Green Day's “Minority”, to be played as a ringback tone to mobile device user B whenever mobile device user A receives a call from mobile device user B. Alternatively, mobile device user A may have already purchased and designated “Minority” to be used as a ringback tone when receiving calls from a particular user, such as mobile device user B. At 730, when mobile device user B calls (or emails) mobile device user A, mobile device user B will hear the “Minority” song and since the CAS 200 has already determined that “Minority” fits mobile device user B's preferences, at 740 mobile device user B will become interested in purchasing the “Minority” song as a ringtone for his/her mobile device, or purchasing Green Day artwork as wallpaper content (when receiving calls from mobile device user A and/or for other purposes), or purchasing digital images of the band Green Day for use as wallpaper, etc. In fact, as mobile device user B calls (or emails) mobile device user A again and again over time, mobile device user B will be presented with that same ringback tone and thus repeatedly be tempted (or marketed) to purchase related content for his/her mobile device.

Eventually, at 740, as a result of repeatedly being exposed to that digital content as a ringback tone when communicating with mobile device user A, mobile device user B purchases rights to that digital content. Mobile device user B may use that digital content for any of a variety purposes (ringtone, ringback tone to be played to another mobile device user when that user calls mobile device user B, playback for listening or viewing by mobile device user B, etc.). At 750, the CAS 200 will update download preferences for mobile device user B when that he/she purchases that digital content, e.g., “Minority”.

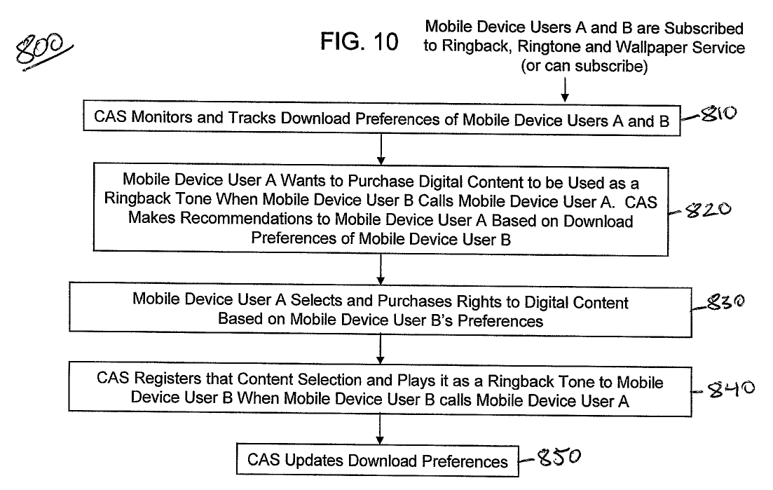

Turning to FIG. 10, another method 800 is described according to a further embodiment of the invention. In this embodiment, the CAS recommends to a mobile device user content for use as a ringback tone based on the download preferences of that mobile device user. At 810, the CAS 200 monitors and tracks download preferences of mobile device users, e.g., mobile device users A and B. At 820, when mobile device user A is looking for digital content to be used as a ringback tone played to mobile device user B when he/she calls mobile device user A, the CAS 200 recommends certain digital content based on the download preferences of mobile device user B. For example, mobile device user B may has downloaded Green Day songs for his/her ringtones or has downloaded entire Green Day songs for general playback on his/her mobile device. Thus, the CAS recommends another Green Day song to mobile device user A. At 830, mobile device user A makes that selection and purchases the rights to that digital content to be used as a ringback tone when mobile device user B calls mobile device user A. At 840, the CAS 200 registers that selection and when mobile device user B calls mobile device user A, mobile device user B will hear the selected (other) Green Day song as a ringback tone. At 850, the CAS 200 updates the download preferences of mobile device users A and B.

To summarize, FIGS. 9 and 10 depict a system and method for delivering content and/or services to a mobile device, comprising storing preference information representing digital content used by mobile device users; transmitting to a first mobile device user preference information related to the types of digital content downloaded by a second mobile device user; and selecting by the first mobile device user a particular digital content item/asset based on the preference information (to be used, for example, as a ringback tone played to the second mobile device user when the second mobile device user calls said first mobile device user). Further, the second mobile device user may select and purchase (e.g., download) digital content related to the ringback tone selected by the first mobile device user.

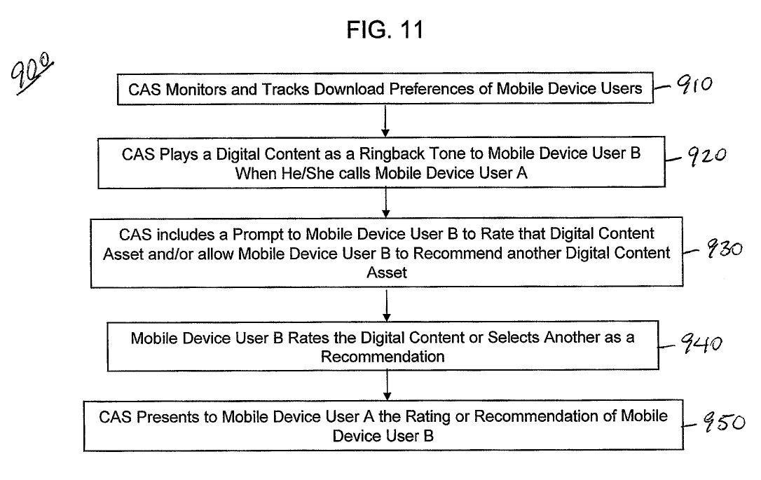

Turning to FIG. 11, a method 900 according to another embodiment of the invention is described. According to this embodiment, the CAS 200 facilitates mobile device users to provide feedback on digital content and to allow a calling mobile device user to make recommendations on digital content, such as content to be used as a ringback tone. At 910, the CAS monitors and tracks download preferences of mobile device users, e.g., mobile device users A and B. For example, mobile device user A has selected a particular digital content asset for use as ringback tone played to mobile device user B when he/she calls mobile device user A. At 920, the CAS plays that selected digital content to mobile device user B when he/she calls mobile device user A. At 930, the CAS 200 transmits a prompt, such as a voice prompt or a graphical user interface (GUI) in the form of a text dialog, to rate that digital content that was played to mobile device user B. The method of rating may involve the mobile device user B clicking an icon indicating like or dislike, selecting a measure that indicates a degree of approval (number of stars or rating between 1 and 5 with 1 being the lowest and 5 being the highest), textual or voice comment made by the mobile device user B, etc. The mobile device user B's response to the feedback or rating request may be in the form of a voice response or a data response (selection of a particular numeral value or graphical data element value representing a rating). The prompt may be presented anytime while the digital content is being play as a ringback tone or at the completion of the call between the parties. Alternatively, at 930, the CAS 200 may include in the prompt the ability to allow mobile device user B to recommend back to mobile device user A a particular digital content asset or browse a database of available digital media content to recommend to mobile device user A. At 940, the mobile device user B rates the digital content and/or selects another digital content asset as a recommendation. At 950, the CAS 200 stores mobile device user B's rating of that digital content asset (and/or recommendation of another digital content asset) and presents that information to mobile device user A, upon completion of the call or during some other communication session. In this way, a social community around digital media content (used as ringback tones or in a different manner) is created to allow mobile device users to review, rate and recommend digital content. When users browse available digital media content, the CAS 200 may display or present reviews or ratings to help users in their selections.

To summarize the embodiment of FIG. 11, a method is provided for tracking user review information of digital media content (used, e.g., as ringback tones), comprising playing a digital content asset as a ringback tone to a first mobile device user when the first mobile device user calls a second mobile device user; prompting the first mobile device user to provide feedback or a rating of the digital content asset (or provide a recommendation of another digital content asset); receiving the feedback or rating (and/or recommendation) from the first mobile device user; and presenting the feedback or rating (and/or recommendation) of the first mobile device user to the second mobile device user.

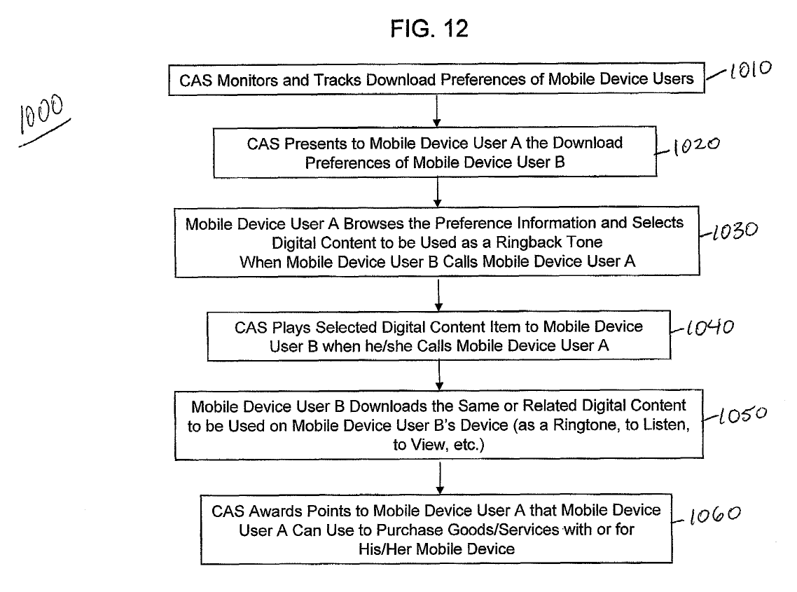

FIG. 12 illustrates another a method 1000 according to still a further embodiment of the invention. In this embodiment, a system and method is provided for viral marketing of digital media content to mobile device users for use as ringback, ringtones, wallpaper, listening/viewing with a media player function on the mobile device, etc. The CAS 200 stores and manages data for a rewards program whereby a mobile device user is awarded “points” or credits based on the number of times that mobile device user gets other mobile device users to purchase new digital media assets. At 1010, the CAS 200 monitors and tracks download preferences of mobile device users, e.g., mobile device users A and B. Since the CAS 200 maintains a database of preferences as to the digital content each mobile device user has downloaded, the CAS 200 can share this preference information with mobile device users. For example, at 1020, while mobile device user A is browsing digital content, he/she may request to see the download preferences of mobile device user B to be used as a ringback tone when mobile device user B calls mobile device user A. At 1030, mobile device user A selects a digital content asset that mobile device user A knows, from the preference data, that mobile device user B has not already downloaded but knows it matches the preferences of mobile device user B. The selected digital content asset is used as a ringback tone that is played to mobile device user B when he/she calls mobile device user A. At 1040, the CAS 200 plays that ringback tone to mobile device user B when he/she calls mobile device user A. At 1050, mobile device user B becomes so interested in that digital content asset (from hearing it as a ringback tone) that he/she purchases and downloads that asset for use on his/her mobile device, such as a ringtone, wallpaper or playback using a media player on the mobile device. At 1060, the CAS 200 tracks the purchase made by mobile device user B and awards points to mobile device user A for contributing to the sale to mobile device user B. Thus, mobile device user A can accumulate points for promoting digital content to the other mobile device users that call mobile device user A. The CAS 200 tracks of those points and mobile device user A can redeem the points for purchasing digital content or for other goods or services from his/her mobile device (or by other means-via a web site from a PC) related or unrelated to the use of the mobile device.

To summarize the embodiment on FIG. 12, a method is provided for promoting the sale of digital content to mobile device users, comprising selecting by a first mobile device user a digital content asset for use as a ringback tone to be played to a second mobile device user when the second mobile device user calls the first mobile device user; playing the digital content asset to the second mobile device user when the second mobile device user calls the first mobile device user; the second mobile device user downloading digital content or purchasing a service related to the digital content asset played to the second mobile device user; awarding one or more redeemable points or credits to the first mobile device user when the second mobile device user downloads the digital content asset or purchases a service related thereto.

The system, device and methods described herein may be embodied in other specific forms without departing from the spirit or essential characteristics thereof. The foregoing embodiments are therefore to be considered in all respects illustrative and not meant to be limiting.

What is claimed is:

1. A method for selection of digital content to be presented to a caller, comprising:
a. supplying information to a mobile device describing a plurality of digital media content one of which may be presented to a caller when said caller calls said mobile device; and
b. selecting one of the plurality of digital media content for presentation to the caller when the caller calls the mobile device.

2. The method of claim 1, and further comprising detecting the call placed by the caller to the mobile device, and wherein said (a) supplying is after said detecting.

3. The method of claim 1, wherein (a) supplying comprises transmitting a list identifying the plurality of digital media content to said mobile device for display on said mobile device.

4. The method of claim 1, wherein (a) supplying further comprises identifying a digital media content currently assigned to the caller for presentation to the caller when the caller calls the mobile device.

5. The method of claim 1, and further comprising receiving from said caller information identifying one or more caller-recommended digital media content to be presented to said caller when calling said mobile device.

6. The method of claim 5, wherein (a) supplying comprises including information identifying said one or more caller-recommended digital media content.

7. The method of claim 5, wherein (b) selecting comprises selecting from one of the caller-recommended digital media content.

8. The method of claim 1, wherein (b) selecting is performed by a user of said mobile device.

9. The method of claim 1, and further comprising presenting a selected one of the digital media content to the caller when the caller calls the mobile device, and wherein the caller is a user of another mobile device.

10. A method for selection of digital content to be presented to a caller when calling a mobile device, comprising:
a. supplying information to the caller describing a plurality of digital media content one of which may be presented to the caller when said caller calls said mobile device; and
b. receiving from the caller a selection of one of the plurality of digital media content.

11. The method of claim 10, wherein said caller is a user of another mobile device, and wherein (a) supplying comprises transmitting a list to the mobile device of said caller.

12. A system for enabling selection of digital content to be presented to a caller when calling a mobile device, comprising:
a. a plurality of mobile devices capable of mobile wireless communication; and
b. a computing device that manages communication services to a plurality of mobile devices, wherein the computing device supplies to a first mobile device information describing a plurality of digital media content one of which may be presented to a caller when said caller calls said mobile device, and receives a selection of one of the plurality of digital media content.

13. The system of claim 12, wherein the computing device detects the call placed by the caller to the first mobile device and supplies the information after detecting the call.

14. The system of claim 12, wherein the computing device transmits a list identifying the plurality of digital media content to said first mobile device for display on said first mobile device.

15. The system of claim 12, wherein the computing device further supplies information identifying a digital media content currently assigned to the caller for presentation to the caller when the caller calls the first mobile device.

16. The system of claim 12, wherein the computing device supplies the information describing the plurality of digital media content including digital media content recommended by said caller.

17. The system of claim 12, wherein the computing device receives the selection from a user of the first mobile device.

18. A method for marketing content to mobile device users, comprising:
a. storing preference information associated with digital media content used or downloaded by mobile device users including first and second mobile device users;
b. transmitting to the first mobile device user recommended digital media content based on preference information for the second mobile device user; and
c. selecting by the first mobile device user digital media content based on said recommended digital media content, wherein said selected digital media content is to be presented to said second mobile device user when said second mobile device user calls said first mobile device user.

19. The method of claim 18, and further comprising said second mobile device user downloading digital media content corresponding or related to said selected digital content asset.

20. The method of claim 19, wherein said second mobile device user downloads the digital media content for use as a ringtone, wallpaper or other media viewing or listening function.

21. A method for marketing content to mobile device users, comprising:
a. storing preference information associated with digital media content used or downloaded by mobile device users including first and second mobile device users;
b. selecting digital media content for presentation to the second mobile device user when the second mobile device user calls the first mobile device user; and
c. receiving from the second mobile device user information indicating the second mobile device user's rating of the selected digital media content.

22. The method of claim 21, and further comprising transmitting to the first mobile device user the information indicating the second mobile device user's rating.

23. The method of claim 21, and further comprising receiving from the second mobile device user information indicating a recommendation for at least one other digital media content, and presenting to the first mobile device user the information indicating the recommendation.

24. The method of claim 21, and further comprising receiving from the second mobile device user information indicating a recommendation for at least one other digital media content, and presenting to the first mobile device user the information indicating the second mobile device user's rating and the recommendation received from the second mobile device user.

25. A method for marketing content to mobile device users, comprising:
a. storing preference information associated with digital media content used or downloaded by mobile device users including first and second mobile device users;
b. presenting to the first mobile device user preference information of the second mobile device user;
c. receiving from the first mobile device user a selection of digital media content based on the user preference information of the second mobile device user that is presented to the first mobile device user; and
d. presenting to the second mobile device user the digital media content selected by the first mobile device user when the second mobile device user calls the first mobile device user.

26. The method of claim 25, and further comprising receiving from the second mobile device user a request to download and/or purchase rights to use digital media content corresponding or related to the digital media content selected by the first mobile device user for presentation to the second mobile device user.

27. The method of claim 25, and further comprising awarding the first mobile device user points for contributing to the second mobile device user's purchase.

28. The method of claim 27, and further comprising storing data representing points awarded to the first mobile device user for purchases made by other mobile device users for which the first mobile device user selects for presentation digital media content that the other mobile device users have not yet purchased.

29. A method for tracking reviews of digital content by mobile device users, comprising:
a. playing digital media content to a first mobile device user when said first mobile device user calls a second mobile device user;
b. prompting said first mobile device user to rate the digital media content;
c. receiving a rating from said first mobile device user; and
d. presenting said rating of said first mobile device user to said second mobile device user.

30. The method of claim 29, wherein receiving comprises receiving a voice response or data response from the first mobile device user.

31. The method of claim 29, and further comprising receiving from said first mobile device user a recommendation for other digital media content, and presenting information pertaining to the recommended digital media content to said second mobile device user.

32. A method for promoting the sale of digital content to mobile device users, comprising:
a. selecting by a first mobile device user digital media content to be played to a second mobile device user when said second mobile device user calls said first mobile device user;
b. playing said digital media content to said second mobile device user when said second mobile device user calls said first mobile device user; and
c. downloading to the mobile device of said second mobile device user digital media content related to the digital media content played to said second mobile device user.

33. The method of claim 32, and further comprising awarding points or credits to said first mobile device user when said second mobile device user downloads digital media content related to said digital media content played to said second mobile device user.

34. The method of claim 33, and further comprising accumulating data representing said points awarded to said first mobile device user each time another mobile device user downloads digital media content related to digital media content selected by said first mobile device user for presentation to other mobile device users.

35. A system for marketing content to mobile device users, comprising:
a. a plurality of mobile devices capable of mobile wireless communication; and
b. a computing device that manages communication services to a plurality of mobile devices, wherein the computing device stores preference information associated with digital media content used or downloaded by mobile device users including first and second mobile device users and facilitating marketing of digital media content to mobile device users based on the preference information.

36. The system of claim 35, wherein the computing device generates recommendations for digital media content based on preference information for the second mobile user, transmits the recommendations to the first mobile device user, and receives from the first mobile device user a selected digital media content based on said recommendations, wherein the selected digital media content is to be presented to the second mobile device user when said second mobile device user calls said first mobile device user.

37. The system of claim 36, wherein the computing device receives a request from the second mobile device user to download digital media content corresponding or related to the selected digital media content.

38. The system of claim 36, wherein the computing device receives from the second mobile device user information indicating the second mobile device user's rating of the selected digital media content.

39. The system of claim 38, wherein the computing device transmits to the first mobile device user the information indicating the second mobile device user's rating.

40. The system of claim 38, wherein the computing device receives from the second mobile device user information indicating a recommendation for at least one other digital media content, and transmits to the first mobile device user the information indicating the recommendation.

41. The system of claim 35, wherein the computing device awards points to said first mobile device user when other mobile device users download digital media content related to digital media content played to those mobile device users when calling said first mobile device user.
